(19) United States
(12) Patent Application Publication
(10) Pub. No.: US 2024/0183372 A1
(43) Pub. Date: Jun. 6, 2024

(54) Pin and Grommet Assembly

(71) Applicant: Illinois Tool Works Inc., Glenview, IL (US)

(72) Inventor: Mark O. Lepper, Oak Park, IL (US)

(21) Appl. No.: 18/529,275

(22) Filed: Dec. 5, 2023

Related U.S. Application Data
(60) Provisional application No. 63/430,406, filed on Dec. 6, 2022.
(60) Provisional application No. 63/430,709, filed on Dec. 7, 2022.

(51) Int. Cl. F16B 5/02; F16B 35/04; F16B 37/04

(52) U.S. Cl. CPC F16B 5/0258; F16B 35/041; F16B 37/043

(57) ABSTRACT

Disclosed is a pin and grommet (P&G) fastener assembly for forming a connection between a first component and a second component. The P&G fastener assembly includes a grommet and a fastener that provide a step reduction in diameter toward the leading end of their respective parts. The grommet includes a collar and a body to couple with the second component via an opening therein. The body includes a first body portion and a second body portion having a diameter that is less than that of the first body portion. The first body portion includes one or more retention wings to engage the second component via the opening. The second body portion includes one or more pawls to engage the fastener via a ratcheting feature formed in or on the second shaft portion. The fastener includes a head portion and a shank portion extending therefrom. The fastener retains the first component relative to the second component via the grommet. The shank portion defines a shaft includes a first shaft portion having a first diameter and a second shaft portion having a second diameter that is less than the first diameter.

### CROSS-REFERENCE

The present application claims priority to U.S. Provisional Patent Application No. 63/430,406, filed Dec. 6, 2022, and entitled “Pin and Grommet Assembly,” and also claims priority to U.S. Provisional Patent Application No. 63/430,709, filed Dec. 7, 2022, and entitled “Pin and Grommet Assembly,” which is hereby incorporated by reference in its entirety.

### BACKGROUND

Automotive components require fastening techniques that are simple to manufacture and assemble. Further, fastening techniques should above all be reliable and efficient. In order to secure a first panel to a second panel, a fastener may be used, such as a pin and grommet fastener.

In some examples, the fastener may include a seal to seal the opening in the secondary panel. The seal may be fabricated from a seal material that is different from the fastener material used to fabricate the rigid portions of the fastener (e.g., a fastener stem, head, etc.). It is sometimes advantageous to provide a fastener assembly where the seal is integral with a grommet (or portion thereof), but still fabricated using a flexible seal material that enhances the sealing capabilities of the seal portion, which would not be of the same material as the other more rigid parts of the fastener assembly.

During assembly, the rigid components of a fastener assembly sometimes physically interfere or interact with (e.g., scrape or rub against) the seal, which can damage and/or reduce the effectiveness of the seal. Despite various advancements to date, it would be desirable to provide a fastener assembly with an integral seal portion that yields improved clearance between the rigid components of the fastener assembly and integral seal portion.

### SUMMARY

The present disclosure relates generally to a fastener assembly that provides, inter alia, improved clearance between the rigid components of the fastener assembly and integral seal portion, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates an assembled perspective view of an example fastening system forming a connection between two components using a fastener assembly in accordance with an aspect of this disclosure.

FIG. 1b illustrates an assembled perspective view of the fastener assembly of FIG. 1a.

FIGS. 1c and 1d illustrate, respectively, disassembled and assembled side views of the fastening system using the fastener assembly.

FIG. 2a illustrates a perspective assembly view of the fastener assembly.

FIG. 2b illustrates a side assembly view of the fastener assembly.

FIGS. 2c and 2d illustrate, respectively, assembled perspective and side cross-sectional views of the fastening system taken along cutline A-A (FIG. 1a).

FIGS. 3a and 3b illustrate, respectively, a top and bottom isometric views of the fastener in accordance with an aspect of this disclosure.

FIGS. 3c through 3f illustrate side views of the fastener.

FIGS. 3g and 3h illustrate, respectively, top and bottom plan views of the fastener.

FIGS. 4a and 4b illustrate, respectively, a top and bottom isometric views of the retainer component in accordance with an aspect of this disclosure.

FIGS. 4c through 4f illustrate side views of the retainer component.

FIGS. 4g and 4h illustrate, respectively, top and bottom plan views of the retainer component.

FIGS. 5a and 5b illustrate, respectively, a top and bottom isometric views of the seal in accordance with an aspect of this disclosure.

FIGS. 5c through 5f illustrate side views of the seal.

FIGS. 5g and 5h illustrate, respectively, top and bottom plan views of the seal.

FIG. 6a illustrates a side elevation detailed view of the fastener of FIGS. 3a through 3h.

FIG. 6b illustrates a side elevation detailed view of the fastener in accordance with another aspect of this disclosure.

FIG. 6c illustrates a side elevation detailed view of the fastener in accordance with another aspect of this disclosure.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a pin and grommet fastener assembly having a fastener assembly and a grommet assembly configured to cooperate with only another to yield a reduced overall diameter. As will be appreciated, the disclosed fastener assembly and a grommet of the grommet assembly exhibit a step reduction in diameter toward the leading end of their respective parts.

The step reduction maintains a larger fastening diameter, while reducing the diameter at locations to mitigate issues with assembly clearance and internal seal interference. For example, the disclosed fastener assembly improves clearance with edges of opening in a component during, for example, swing-type assembly. In addition, the disclosed fastener assembly reduces interference between the fastener (e.g., pin) and seal (e.g., positioned on the grommet) during removal and reinstallation.

In one example, a pin and grommet (P&G) fastener assembly for forming a connection between a first component and a second component comprises: a grommet comprising a body and a collar, wherein the body is configured to couple with the second component via an opening therein; and a fastener comprising a head portion and a shank portion extending therefrom, wherein the fastener is configured to retain the first component relative to the second component via the grommet, and wherein the shank portion defines a shaft comprising a first shaft portion having a first diameter and a second shaft portion having a second diameter that is less than the first diameter.

In another example, a fastener for retaining a first component relative to a second component via a grommet comprises: a head portion; and a shank portion extending from the head portion, wherein the shank portion defines a shaft comprising a first shaft portion having a first diameter and a second shaft portion having a second diameter that is less than the first diameter, and wherein the second shaft portion comprises a ratcheting feature configured to engage the grommet.

In yet another example, a grommet for retaining a first component relative to a second component via a fastener comprises: a collar; and a body configured to couple with the second component via an opening therein, wherein the body comprises a first body portion and a second body portion having a diameter that is less than that of the first body portion, wherein the first body portion comprises one or more retention wings configured to engage the second component via the opening, and wherein the second body portion comprises one or more pawls configured to engage the fastener via a ratcheting feature formed in or on a shaft of the fastener.

In some examples, the second shaft portion comprises a ratcheting feature configured to engage the grommet.

In some examples, the ratcheting feature comprises a plurality of annular valleys.

In some examples, the body comprises a first body portion and a second body portion having a diameter that is less than that of the first body portion.

In some examples, the first body portion comprises one or more retention wings configured to engage the second component via the opening.

In some examples, the second body portion comprises one or more pawls configured to engage the fastener via a ratcheting feature formed in or on the second shaft portion.

In some examples, the shank portion defines a sloped portion between the first shaft portion and the second shaft portion to provide a smooth transition between the first diameter and the second diameter.

In some examples, the grommet further comprises a flexible seal that is integrally coupled with the collar.

In some examples, the flexible seal is fabricated from a first material and the grommet is fabricated from a second material that is different from the first material

The grommet and the flexible seal can be fabricated to form a grommet assembly via a two-shot injection process or an over-molding process.

In some examples, the shank portion defines a conical tip at a distal end of the second shaft portion, wherein a maximum diameter of the conical tip is less than or equal to the second diameter.

In some examples, the head portion is configured to couple with a doghouse structure of the first component.

In some examples, the ratcheting feature comprises a plurality of annular valleys.

In some examples, the shank portion defines a sloped portion between the first shaft portion and the second shaft portion to provide a smooth transition between the first diameter and the second diameter.

In some examples, the shank portion defines a conical tip at a distal end of the second shaft portion, wherein a maximum diameter of the conical tip is less than or equal to the second diameter.

In some examples, the head portion is configured to couple with a doghouse structure of the first component.

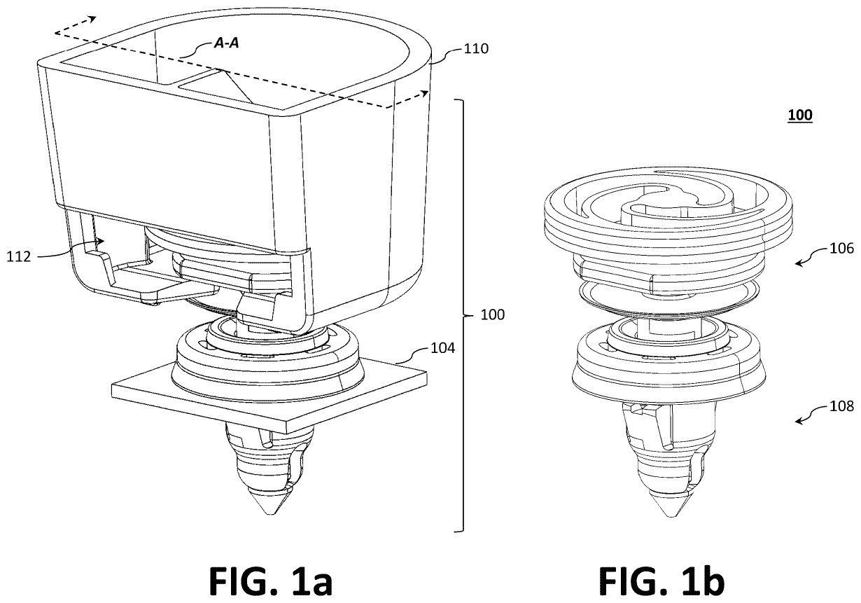

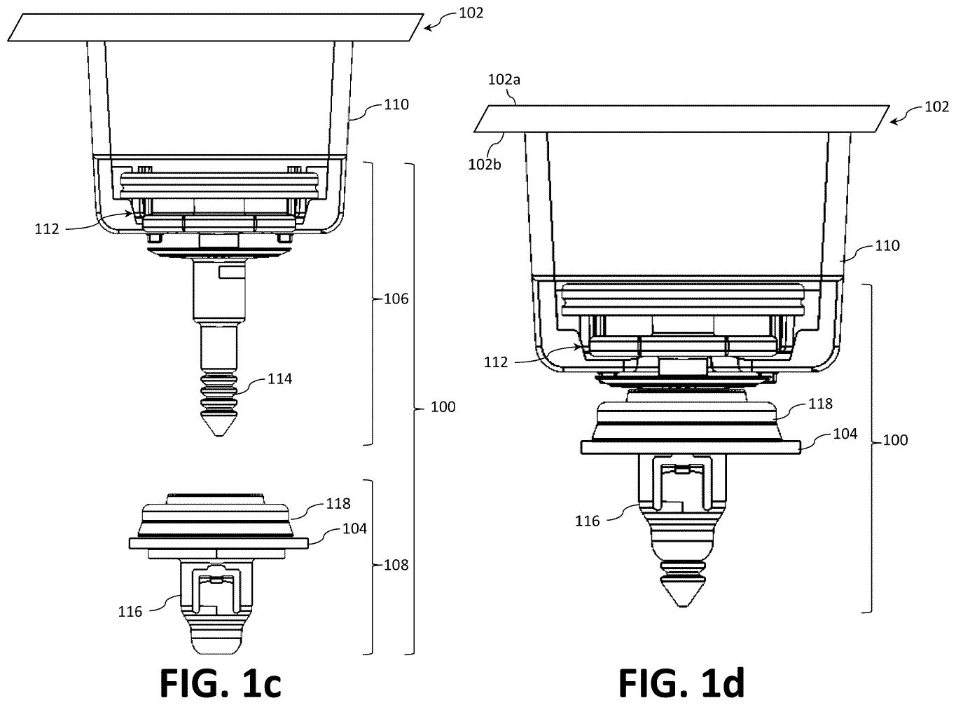

FIG. 1a illustrates an assembled perspective view of an example fastening system forming a connection between a first component 102 and a second component 104 using a fastener assembly 100 in accordance with aspects of this disclosure. The first component 102 is omitted from FIG. 1a for illustrative purposes, but non-limiting examples are represented in FIGS. 1c and 1d. FIG. 1b illustrates an assembled perspective view of the fastener assembly 100 of FIG. 1a. FIGS. 1c and 1d illustrate, respectively, disassembled and assembled side views of the fastening system using the fastener assembly 100.

The illustrated fastener assembly 100 is configured to form a blind connection between the first component 102 and the second component 104. While only a single fastener assembly 100 illustrated in the example, it should be appreciated that multiple fastening assemblies 100 may be used to couple a first component 102 to a second component 104, depending on the number of fastener points needed between the first and second components 102, 104. For example, larger components and panels typically require multiple fastening points.

The first component 102 and the second component 104 may be, for example, automotive panels. Depending on the application, the first component 102 and the second component 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first components 102 include, without limitation, door trim panels, moldings, trim pieces, and other substrates (whether used as interior or exterior surfaces).

The first component 102 may define an A-surface 102a and a B-surface 102b (illustrated as an undersurface). The A-surface 102a, also called a class A surface, is typically the surface that is visible after assembly and, for that reason, is more aesthetically pleasing (e.g., textured, coated, or otherwise decorated) and typically free of attachment devices and/or related features. Conversely, the B-surface 102b, also called a class B surface, is typically the surface that is not visible after assembly and typically includes various attachment devices and/or related features, such as the illustrated doghouse interface 110 and receptacle 112.

The second component 104 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like.

The fastener assembly 100 generally comprises a fastener 106 (e.g., a male component) and a grommet assembly 108 (e.g., a female component). As illustrated, the fastener assembly 100 is attached to the B-surface 102b via the fastener 106 and, depending on the material type, may be attached to the B-surface 102b after fabrication of the first component 102 via, for example, the doghouse interface 110. In another example, a top portion of the fastener 106 may be adhesively secured to the first component 102. In the illustrated examples, the fastener assembly 100 is configured as a pin and grommet (P&G) fastener with the seal 118 coupled to, or integrated with, the grommet 116. Specifically, the fastener 106 is illustrated as a pin-type fastener assembly 100 configured to engage the grommet assembly 108.

The illustrated doghouse structure 110 is composed of a plurality of doghouse sidewalls defining the receptacle 112 therein. The receptacle 112 is sized and shaped to receive a portion of the fastener assembly 100 (e.g., a fastener 106). The doghouse sidewalls may include one or more features shaped to increase engagement with the fastener 106 and/or to serve as stops for the fastener 106. In some examples, the features may exhibit a soft click as the fastener 106 is secured in the receptacle 112. The doghouse structure 110 may be molded during molding of the first component 102; however, in some examples, they may be fabricated separately and later joined to one another (e.g., using adhesive, mechanical fasteners, etc.). The doghouse structure 110 is contemplated to be modified in size and shape to suit individual applications.

The fastener 106 and a grommet assembly 108 (or portion thereof) can be made from various materials, including metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In one example, components of the fastener assembly 100 can be fabricated via mold tooling and a plastic-injection molding process. In another example, components of the fastener assembly 100 can be a printed thermoplastic material component that can be printed with great accuracy and with numerous details, which is particularly advantageous, for example, in creating components requiring complex and/or precise features.

In addition, additive manufacturing techniques obviate the need for mold tooling typically associated with plastic injection molding, thereby lowering up-front manufacturing costs, which is particularly advantageous in low-volume productions. In some examples, components of the fastener assembly 100 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process.

The grommet assembly 108, which is illustrated as having a seal 118 and a grommet 116, is configured to attach to the second component 104, embed in the second component 104, or pass through at least a portion of the second component 104 via, for example, an opening 226 formed therein. For example, the grommet assembly 108 can be snapably secured within the opening 226, which may be generally circular and define a size and shape that is complementary to that of the grommet assembly 108 such that the grommet assembly 108 can be inserted and retained therein. However, openings 226 of other shapes are contemplated.

During assembly of the fastener assembly 100, the fastener 106 is secured within and relative to the grommet 116. To the end, the grommet 116 defines an opening 230 or other cavity configured to receive and couple with the fastener 106 upon assembly. The opening 230 typically conforms to the shape of the fastener 106 such that the fastener 106 is prohibited from shifting relative to the grommet 116.

The assembled fastener assembly 100 can then be attached to the first component 102 via a receptacle 112 defined by the doghouse structure 110. For example, the fastener assembly 100 can be attached to the doghouse structure 110 by an end user (e.g., a Tier supplier) so that the first component 102 can be packaged and shipped to an original equipment manufacturer (OEM) as a part-in-assembly (PIA) for final assembly.

In this example, the first component 102 (with the pre-installed fastener assembly 100 installed thereon) can then be blind-assembled to the second component 104 having the opening 226. For example, a distal end of the fastener assembly 100 (e.g., the tip of the retainer component 116) is aligned with the opening 226 on the second component 104 (e.g., a vehicle panel) and pushed into the opening 226. Once inserted, the grommet 116 fastens to the second component 104 via the opening 226. Upon assembly, as best illustrated in FIG. 1d, the second component 104 is covered at least partially by the first component 102.

To disassemble the fastener assembly 100, the first component 102 is pulled directly from the second component 104 until fastener separation occurs between the fastener 106 and the grommet 116. For reinstallation of the first component 102, the fastener 106 is aligned with the grommet 108 and pushed back to its previous retention position for reassembly.

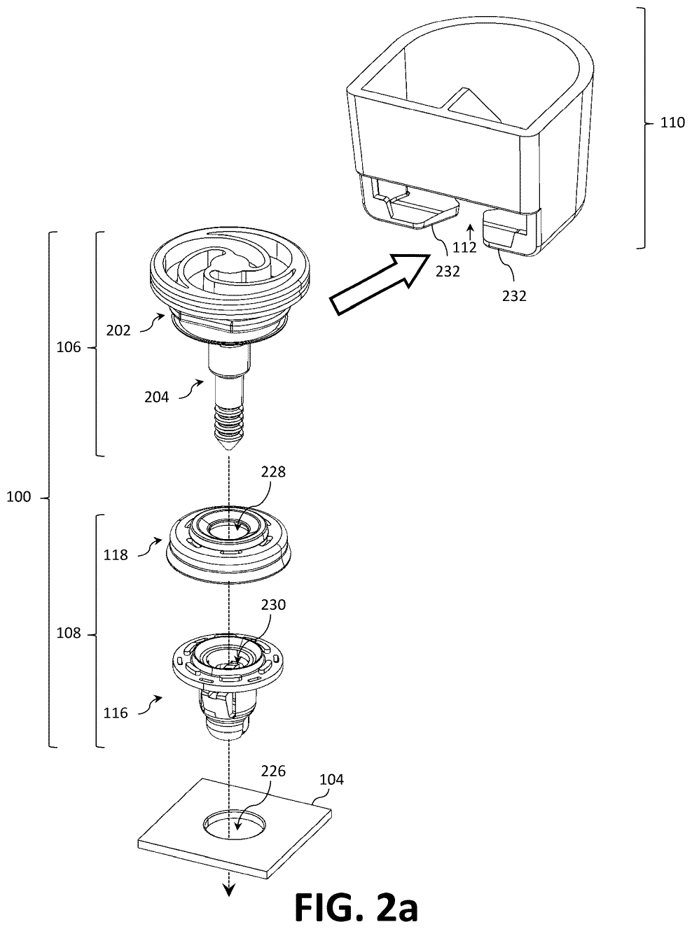

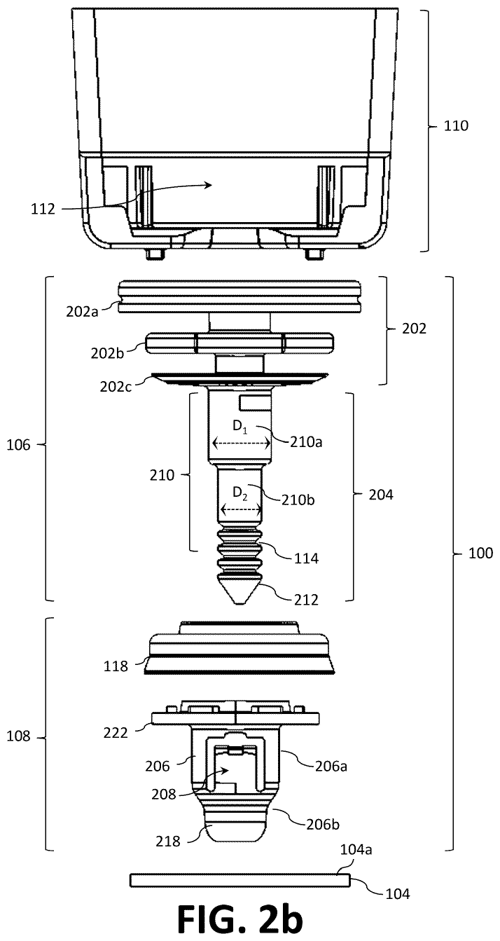

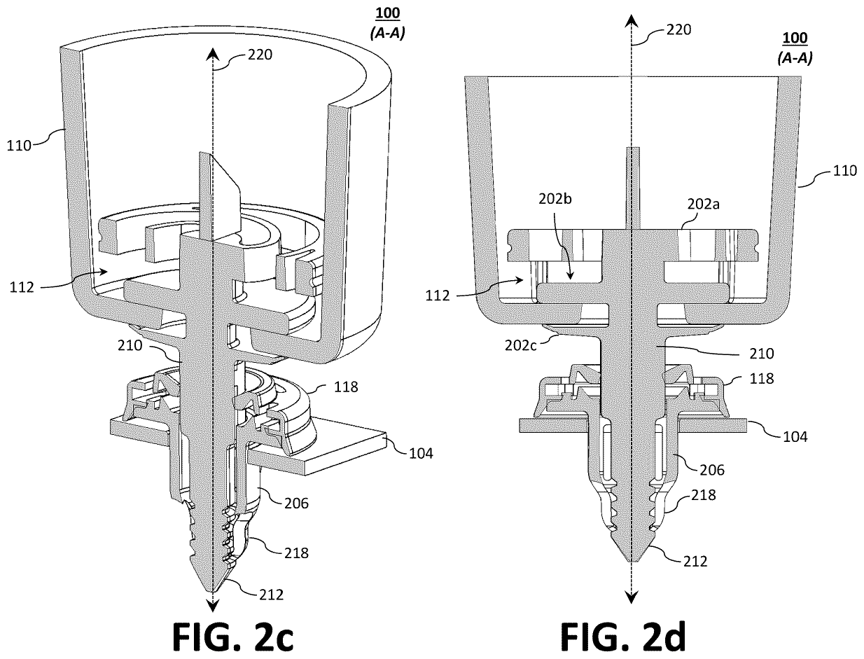

FIG. 2a illustrates a perspective assembly view of the fastener assembly 100. FIG. 2b illustrates a side assembly view of the fastener assembly 100. FIGS. 2c and 2d illustrate, respectively, assembled perspective and side cross-sectional views of the fastening system taken along cutline A-A (FIG. 1a). As discussed, the illustrated fastener assembly 100 generally comprises the fastener 106 and the grommet assembly 108, which is configured to secure the fastener 106 relative thereto.

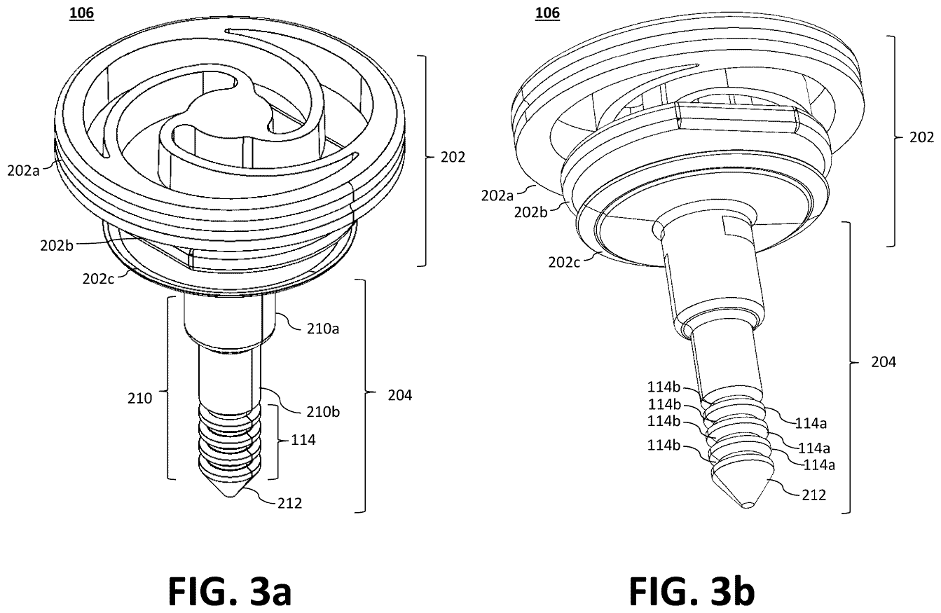

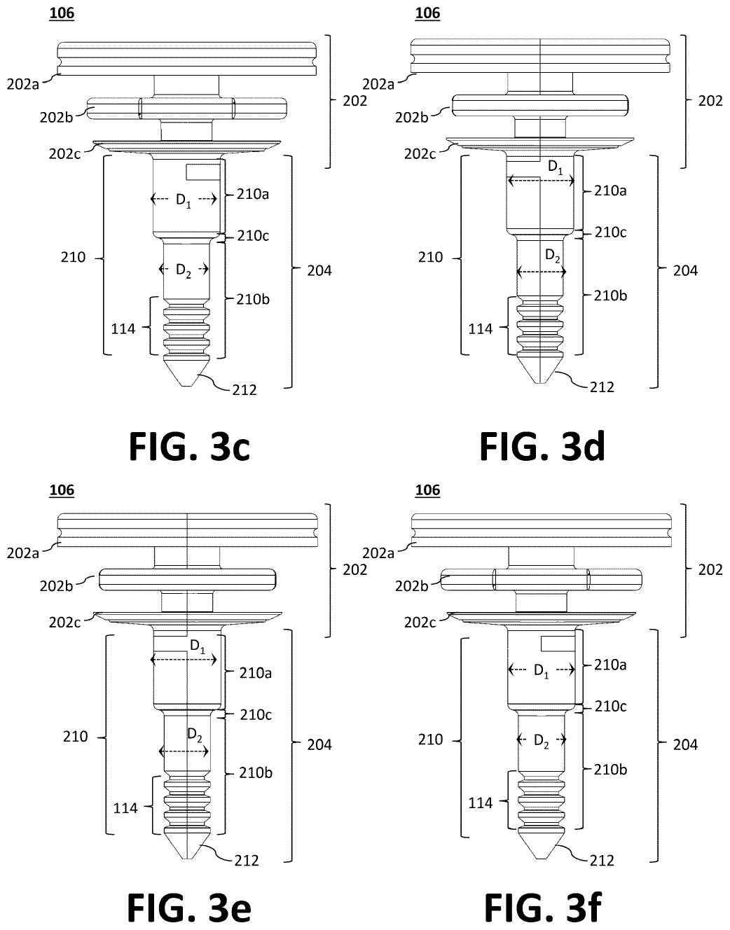

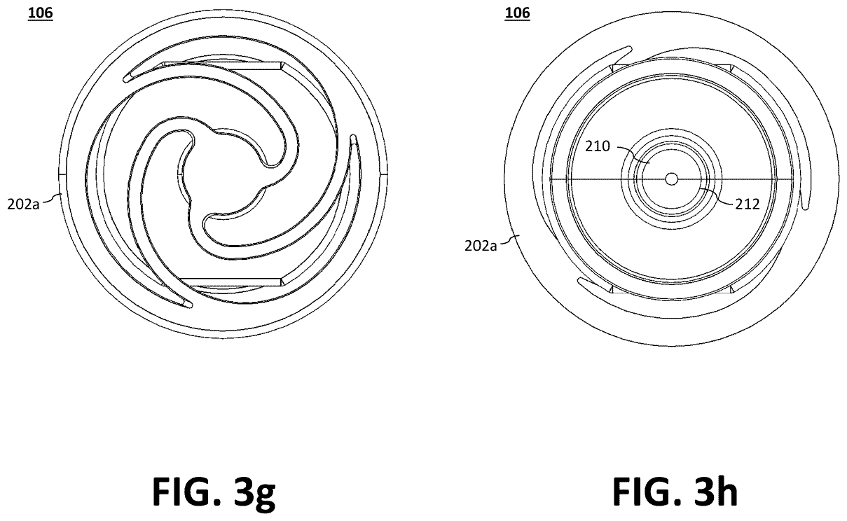

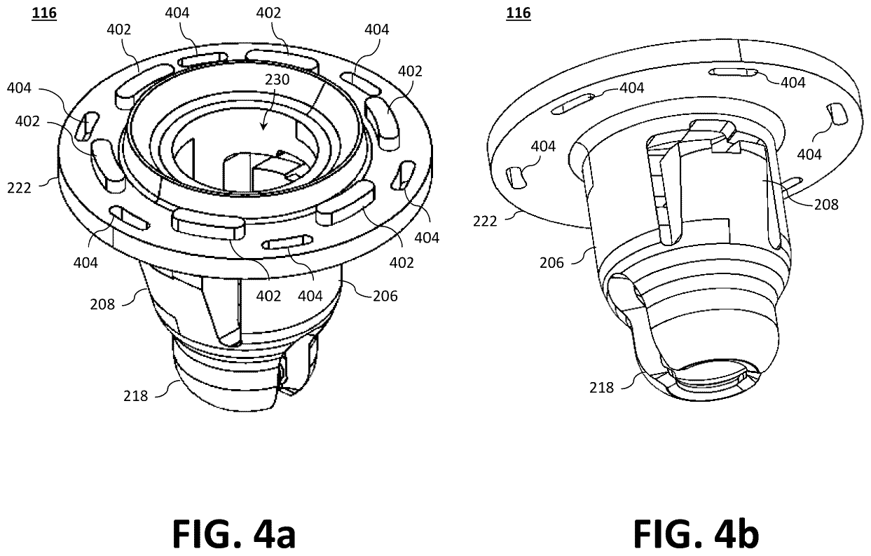

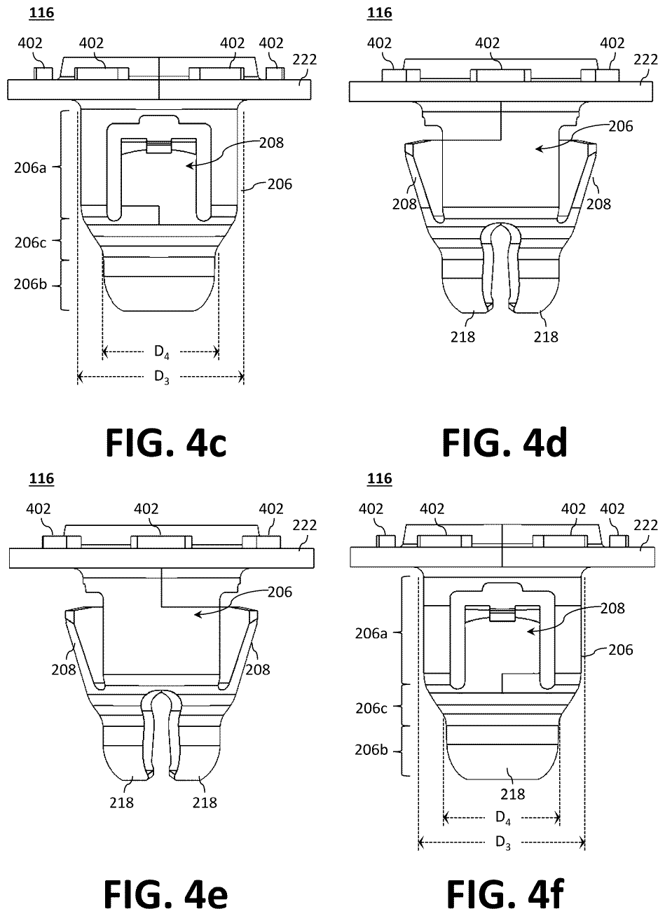

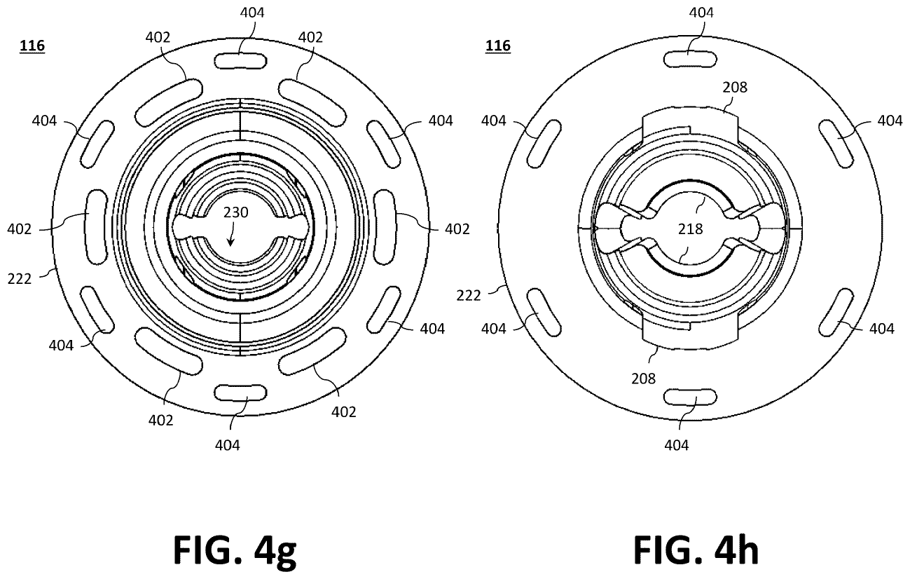

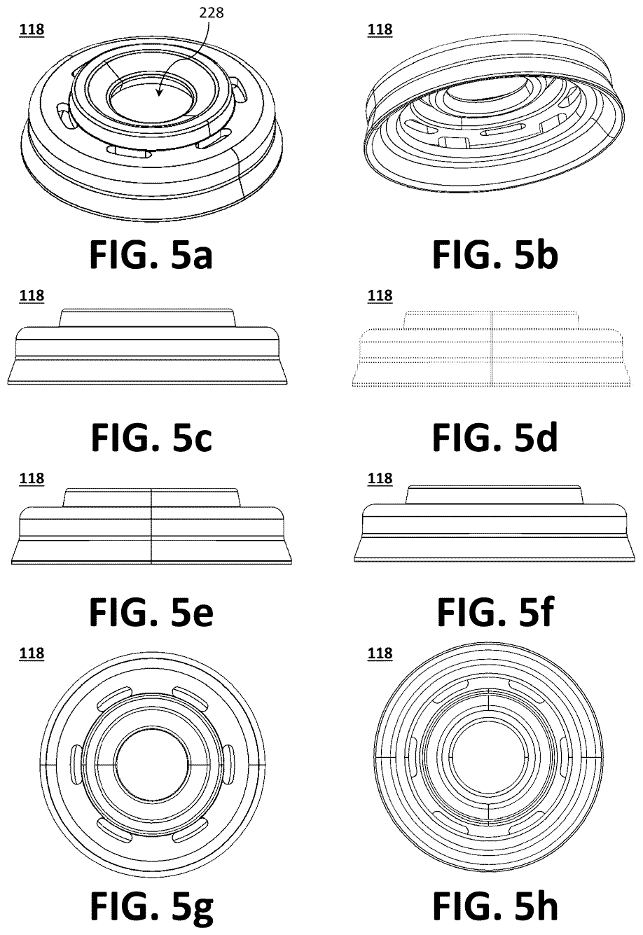

The various components of the fastener assembly 100 are illustrated in greater detail at FIGS. 3a through 3h, FIGS. 4a through 4h, and FIGS. 5a through 5h. FIGS. 3a and 3b illustrate, respectively, a top and bottom isometric views of the fastener 106, while FIGS. 3c through 3f illustrate side views of the fastener 106 and FIGS. 3g and 3h illustrate, respectively, top and bottom plan views of the fastener 106. FIGS. 4a and 4b illustrate, respectively, a top and bottom isometric views of the retainer component 116, while FIGS. 4c through 4f illustrate side views of the retainer component 116 and FIGS. 4g and 4h illustrate, respectively, top and bottom plan views of the retainer component 116. FIGS. 5a and 5b illustrate, respectively, a top and bottom isometric views of the seal 118. FIGS. 5c through 5f illustrate side views of the seal 118. FIGS. 5g and 5h illustrate, respectively, top and bottom plan views of the seal 118.

The fastener 106 generally comprises a head portion 202 and a shank portion 204 (illustrated as a pin) extending perpendicularly therefrom. As illustrated, the head portion 202 and the shank portion 204 are concentric relative about a longitudinal axis 220 of the fastener 106 and fastener assembly 100.

The head portion 202 is configured to attach to the first component 102 via, for example, the doghouse structure 110. In the illustrated example, the head portion 202 defines a plurality of parallel planar structures 202a, 202b, 202c that are configured to slide into the receptacle 112 and/or sandwich a portion of the doghouse structure 110, such as the pair of ledges 232.

The shank portion 204, which shares the longitudinal axis 220, comprises a shaft 210 and a tip 212 positioned at its distal end. The shaft 210 employs a step reduction in diameter along the longitudinal axis 220 from the head portion 202 towards the tip 212. The step reduction maintains a desired fastening diameter for the first shaft portion 210a, but reduces the diameter of the second shaft portion 210b to mitigate issues associated with assembly clearance and internal seal interference.

Maintaining the desired fastening diameter for the first shaft portion 210a maintains structural integrity of the assembly and ensures a snug seal against the seal 118, but avoiding potential damage from the ratcheting features 114. Indeed, the inner seal 118 needs to interact with the fastener 106 to seal the fastener assembly 100 from water intrusion. Contact between the ratcheting features 114 of the fastener 106 and the seal 118 during insertion and removal can harm the seal 118; thus, reducing sealing performance. A fastener 106 with a stepped shaft 210; however, mitigates contact. More specifically, the stepped shaft 210 of the fastener 106 mitigate interference between the ratcheting features 114 and the seal 118 via it's reduced diameter; thus significantly reducing damage to the seal 118 and improving sealing over time.

In the illustrated example, the shaft 210 defines a first shaft portion 210a having a first diameter (D₁) and a second shaft portion 210b having a second diameter (D₂) that is less than the first diameter (D₁). In the illustrated example, the first shaft portion 210a and the second shaft portion 210b are cylindrical where the shaft 210 defines a sloped portion 210c (e.g., a portion that is a conical frustum) to provide a smooth transition between the first diameter (D₁) and the second diameter (D₂). While a sloped portion 210c is illustrated, the sloped portion 210c could be omitted such that the transition between the first diameter (D₁) and the second diameter (D₂) is a 90-degree cliff.

The tip 212 of the shank portion 204 is shaped to guide a distal end of the shank portion 204 through the openings 228, 230 formed in the grommet assembly 108. In the illustrated example, the tip 212 is generally conical. The shank portion 204 includes or otherwise defines one or more features configured to engage one or more corresponding features on the grommet assembly 108, such the ratcheting feature 114. AS illustrated, a maximum diameter of the tip 212 is less than or equal to the second diameter (D₂).

The ratcheting feature 114 enables the fastener 106 to be ratchetably pushed further into the grommet 116 to achieve a desired setup height and/or distance between the first component 102 and the second component 104. In this example, the fastener 106 can therefore engage the grommet 116 at one of a plurality of indexed positions of the ratcheting feature 114 of the fastener 106. In the illustrated example, the ratcheting feature 114 includes one or more annular valleys 114b defined between adjacent annular rings 114a formed about the longitudinal axis 220 and configured to engage one or more features of on the grommet assembly 108, such as the one or more pawls 218.

The illustrated grommet assembly 108 generally comprises the grommet 116 and the flexible seal 118. The grommet 116 includes a body 206 and a collar 222, which can be coupled to or integrated with the flexible seal 118 to provide a sealed connection.

The body 206 is illustrated as generally cylindrical and configured to be embedded within the second component 104, while the collar 222 resides at the outer surface 104a of the second component 104. The body 206 defines an interior cavity configured to receive the tip 212 and at least a portion of the shank portion 204, whereas the collar 222 defines an opening 224 configured to secure the fastener 106 relative to the grommet assembly 108.

The body 206 is configured to engage the fastener 106 and/or the second component 104 via one or more retention wings 208 and/or the one or more pawls 218. As illustrated, one or more pawls 218 can be formed at one end of the body 206 (e.g., at the end opposite that of the collar 222) and configured to engaged and retain the fastener 106 during assembly (e.g., via the ratcheting feature 114). When assembled, the one or more pawls 218 snap within one of a plurality of annular valleys 114b of the ratcheting feature 114, thereby mitigating movement of the shaft 210 out of the opening 224.

The body 206, which shares the longitudinal axis 220, also employs a step reduction in diameter along the longitudinal axis 220 from the collar 222 towards the tip of its leading end (e.g., at the pawls 218). The step reduction generally corresponds to and accommodates the step reduction of the fastener 106.

Sometimes alignment to the opening 226 is not ideal or the first component 102 is assembled or at an angle or swung through an arc, in which case the second component 116 can hook onto the opening 226 edge instead of going into the opening 226. To that end, stepping down the diameter of both the fastener 106 and the grommet 116 mitigates the risk of the fastener assembly 100 striking an edge of the opening 226. This is further improved by the overall reduction in length of the fastener assembly 100, which improves angled or arced installation actions.

In the illustrated example, the body 206 defines a first body portion 206a having a first body diameter (D₃) and a second body portion 206b having a second body diameter (D₄) that is less than the first body diameter (D₃). In the illustrated example, the first body portion 206a and the second body portion 206b are generally cylindrical where the body 206 defines a sloped portion 206c (e.g., a portion that is a conical frustum) to provide a smooth transition between the first body diameter (D₃) and the second body diameter (D₄). While a sloped portion 206c is illustrated, the sloped portion 206c could be omitted such that the transition between the first body diameter (D₃) and the second body diameter (D₄) is a 90-degree cliff.

In practice, the flexible seal 118 is integral with the retainer component 116 (i.e., permanently attached) and is positioned on or adjacent the collar 222 to surround the opening 230; however, for ease of illustration, the flexible seal 118 is illustrated separately in FIGS. 5a through 5h. In some examples, the flexible seal 118 is fabricated from a first material (e.g., a pliable material) and the collar 222 is fabricated from a second material (e.g., a rigid material) that is different from the first material. The seal 118 may be embodied as an annular disk. In this example, the seal 118 can be added to the collar using an over-molding process or a two-shot injection process, in which case the material of the seal 118 will conform to the shape of the one or more geometric elements. Thus, the flexible seal 118 can be positioned on the collar 222 to form an integrated grommet assembly 108.

The flexible seal 118 is fabricated from a first material, while the retainer component 116 is fabricated from a second material that is different from the second material. That is, some materials are more conducive for sealing than mechanical attachment. In some examples, the first material may be a pliable and/or conformable seal material, such as a foam material, an elastomeric material (e.g., a thermoplastic elastomer (TPE)), a rubber material (e.g., open cell rubber, closed cell rubber, natural rubber, synthetic rubber, etc.), and the like. The second material is a part material that is generally rigid, such as synthetic or semi-synthetic polymers, composite materials, or a combination thereof. Example part materials include, inter alia, nylon (PA), polyetherimide (PEI), polyoxymethylene (POM), polypropylene (PP), high-density polyethylene (HDPE), acrylonitrile butadiene styrene (ABS), polystyrene (PS), and the like.

The flexible seal 118 is attached to the retainer component 116 at the collar 222. The connection between the flexible seal 118 and the retainer component 116 must be adequate to prevent the flexible seal 118 from detaching from the retainer component 116 prior to, during, and/or post installation, assembly, and/or disassembly by the end user.

To provide an adequate connection between the collar 222 and seal 118, one or both of the collar 222 and seal 118 may include one or more interlocking features to increase the bond; thus, providing a higher degree of mechanical retention. For example, the flexible seal 118 and/or the collar 222 may be shaped to form one or more interlocking features to increase mechanical retention. Example interlocking features include, inter alia, the illustrated protrusions 402 and recesses 404, but could also include other shapes, such as lobes, dovetails, etc. Further, while the flexible seal 118 is illustrated as a circular gasket, it is contemplated that the shape of the flexible seal 118 may be modified in size and/or shape to suit individual applications.

To form the integrated grommet assembly 108, one of the flexible seal 118 or the retainer component 116 can be first molded to provide a desired profile, after which the other of the flexible seal 118 or the retainer component 116 may be molded. The order in which the flexible seal 118 and the retainer component 116 are molded will depend on the manufacturing technique employed. For example, in a two-shot injection process, the flexible seal 118 is molded first, and the retainer component 116 is molded second. An example two-shot injection process is described in commonly owned U.S. Pat. No. 6,752,950 to Martin D. H. Clarke, which is entitled “Two Shot Molding Method And Fastener Clip With Seal Made Thereby.” In other examples, the flexible seal 118 is over-molded onto the collar 222 of the retainer component 116. In an over-molding process, the retainer component 116 would be molded first, and the flexible seal 118 molded second.

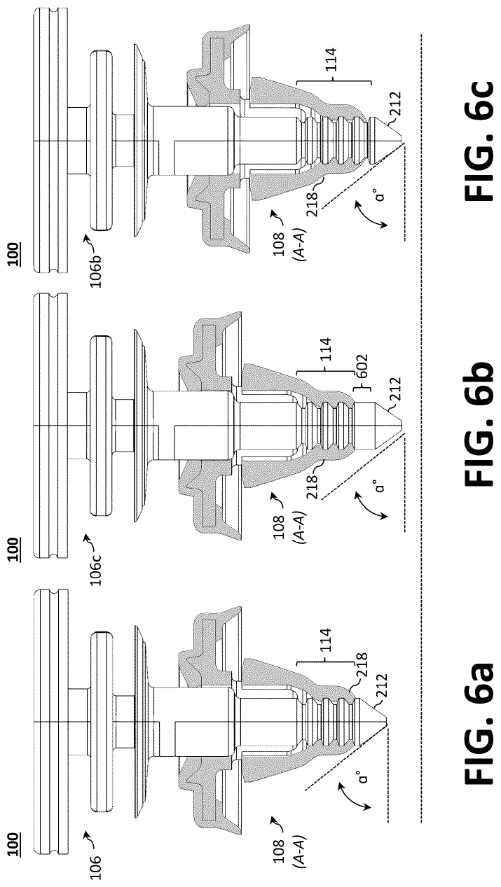

FIG. 6a illustrates a side elevation detailed view of the fastener 106 of FIGS. 3a through 3h, while FIGS. 6b and 6c illustrate side elevation detailed views of fasteners 106a, 106b in accordance with other aspects of this disclosure.

As illustrated in FIG. 6a, the one or more pawls 218 are formed at one end of the body 206 to engaged and retain the fastener 106 during assembly via the ratcheting feature 114. When assembled, the one or more pawls 218 snap within one of a plurality of annular valleys 114b of the ratcheting feature 114 to mitigating movement of the shaft 210 out of the opening 224. In this example, the ratcheting feature 114 is a 4-position ratchet (i.e., it has 4 annular valleys 114b that provide 4 indexed positions) and results in a short length for the second shaft portion 210b and tip 212. In addition to shortening the length of the second shaft portion 210b and tip 212, the narrower diameter (D₂) of the second shaft portion 210b and tip 212 allows for a steepened angle (α), thus making assembled less difficult.

The length of the second shaft portion 210b and tip 212 can be further tailored through adjustments to the shank portion 204 and/or the ratcheting feature 114. For example, while the tip 212 of FIG. 6a is conical and positioned adjacent the ratcheting feature 114, the fastener 106 of FIG. 6b instead employs an extended tip whereby the tip 212 includes a cylindrical portion 602 between the conical portion and the ratcheting feature 114.

With reference to FIG. 6c, the number of annular valleys 114b and annular rings 114a of the ratcheting feature 114 can be adjusted. In this example, the ratcheting feature 114 is a 5-position ratchet (i.e., it has 5 annular valleys 114b), but results in a second shaft portion 210b and tip 212 having a longer length.

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A pin and grommet (P&G) fastener assembly for forming a connection between a first component and a second component, the P&G fastener assembly comprising:
a grommet comprising a body and a collar, wherein the body is configured to couple with the second component via an opening therein; and
a fastener comprising a head portion and a shank portion extending therefrom,
wherein the fastener is configured to retain the first component relative to the second component via the grommet, and
wherein the shank portion defines a shaft comprising a first shaft portion having a first diameter and a second shaft portion having a second diameter that is less than the first diameter.

2. The P&G fastener assembly of claim 1, wherein the second shaft portion comprises a ratcheting feature configured to engage the grommet.

3. The P&G fastener assembly of claim 2, wherein the ratcheting feature comprises a plurality of annular valleys.

4. The P&G fastener assembly of claim 1, wherein the body comprises a first body portion and a second body portion having a diameter that is less than that of the first body portion.

5. The P&G fastener assembly of claim 4, wherein the first body portion comprises one or more retention wings configured to engage the second component via the opening.

6. The P&G fastener assembly of claim 4, wherein the second body portion comprises one or more pawls configured to engage the fastener via a ratcheting feature formed in or on the second shaft portion.

7. The P&G fastener assembly of claim 1, wherein the shank portion defines a sloped portion between the first shaft portion and the second shaft portion to provide a smooth transition between the first diameter and the second diameter.

8. The P&G fastener assembly of claim 1, further comprising a flexible seal that is integrally coupled with the collar.

9. The P&G fastener assembly of claim 8, wherein the flexible seal is fabricated from a first material and the grommet is fabricated from a second material that is different from the first material.

10. The P&G fastener assembly of claim 8, wherein the grommet and the flexible seal are fabricated to form a grommet assembly via a two-shot injection process or an over-molding process.

11. The P&G fastener assembly of claim 1, wherein the shank portion defines a conical tip at a distal end of the second shaft portion, wherein a maximum diameter of the conical tip is less than or equal to the second diameter.

12. The P&G fastener assembly of claim 1, wherein the head portion is configured to couple with a doghouse structure of the first component.

13. A fastener for retaining a first component relative to a second component via a grommet, the fastener comprising:
a head portion; and
a shank portion extending from the head portion,
wherein the shank portion defines a shaft comprising a first shaft portion having a first diameter and a second shaft portion having a second diameter that is less than the first diameter, and
wherein the second shaft portion comprises a ratcheting feature configured to engage the grommet.

14. The fastener of claim 13, wherein the ratcheting feature comprises a plurality of annular valleys.

15. The fastener of claim 13, wherein the shank portion defines a sloped portion between the first shaft portion and the second shaft portion to provide a smooth transition between the first diameter and the second diameter.

16. The fastener of claim 13, wherein the shank portion defines a conical tip at a distal end of the second shaft portion, wherein a maximum diameter of the conical tip is less than or equal to the second diameter.

17. The fastener of claim 13, wherein the head portion is configured to couple with a doghouse structure of the first component.

18. A grommet for retaining a first component relative to a second component via a fastener, the grommet comprising:
a collar; and
a body configured to couple with the second component via an opening therein,
wherein the body comprises a first body portion and a second body portion having a diameter that is less than that of the first body portion,
wherein the first body portion comprises one or more retention wings configured to engage the second component via the opening, and
wherein the second body portion comprises one or more pawls configured to engage the fastener via a ratcheting feature formed in or on a shaft of the fastener.

19. The retainer of claim 18, further comprising a flexible seal that is integrally coupled with the collar.

20. The retainer of claim 19, wherein the flexible seal is fabricated from a first material and the grommet is fabricated from a second material that is different from the first material.
